(19) United States
(12) Patent Application Publication
(10) Pub. No.: US 2003/0182043 A1
(43) Pub. Date: Sep. 25, 2003

(54) Smart system seat controller

(76) Inventors: Mark David Christiansen, Green Valley, CA (US); Gregory Duff Bracy, Moorpark, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/104,696

(22) Filed: Mar. 22, 2002

(51) Int. Cl. G06F 17/00

(52) U.S. Cl. 701/49; 701/3

(57) ABSTRACT

A master controller and various nodes capable of performing disparate functions are configured to cause devices to manipulate an aircraft seat. The nodes operate independently and without interference of the master controller. The master controller provides programs to the nodes. A node initiates a program when commanded to do so by the master controller resulting in a device manipulating an aircraft seat or otherwise operating in conjunction with the aircraft seat. The node also monitors and provides various real time information and performs calibration, power management, diagnostic and other similar types of operations.

### BACKGROUND

The present invention relates to control systems and in particular to distributed control systems for aircraft seats.

Air travel has become a frequently used and preferred type of transportation. Although there have been many modern advances to make aircraft reach their destination faster and safer, air travel, generally, is often tedious and exhausting. Traditional aircraft seats are also often uncomfortable and sometimes makes a flight even more undesirable. Some convenience devices for aircraft seats have been developed to make air travel more enjoyable. However, the implementation of these devices is sometimes difficult.

Cost concerns are quite prominent, as adding convenience devices may be cost prohibitive to manufacture and install in an aircraft seat. Additionally, tremendous flexibility may be required to support standard or legacy devices while at the same time allow an upgrade of the seat, for example, by including additional and improved convenience devices. Also, the seats being on an aircraft poses other unique concerns such as accounting for restrictive and limited space, weight, power, and electromagnetic interference (EMI) requirements.

Additionally, typical convenience devices that have been developed provide minimal amounts of seat control which makes the seats less adaptable to a multitude of different persons with different body types flying on any given day. Conventional systems implementing convenience devices in aircraft seats are also often inflexible or limited in system designs for intended applications. In other words, typical systems provide for a predetermined set of devices for a predetermined set of applications, i.e., no mixing and matching of devices for different or custom applications.

### SUMMARY OF THE INVENTION

The invention provides a distributed control system to manipulate devices for aircraft seats. In aspects of the invention, an aircraft seat control system is provided that includes a master controller and one or more nodes. The one or more nodes are coupled to the master controller. At least one of the nodes includes a program. The program is initiated to manipulate an aircraft seat device when a command is received from the master controller. In a further aspect of the invention, the master controller provides the program to the one or more nodes. Also, the master controller detects when a node is added or removed from the system.

In another aspect of the invention, the master controller manages or records power consumed by the one or more nodes. When a specific power threshold is exceeded, the master controller disables a node or causes a node to reduce speed of an actuator. In a further aspect of the invention, the master controller controls the nodes to manipulate aircraft seat devices within predetermined safety zones. The safety zones are determined based on using positional information and fuzzy logic and/or a mathematical algorithm. In one aspect of the invention, a master controller is also provided that supplies power to the nodes, master controller and other in-seat devices.

In yet another aspect of the invention, the master controller has various programs for various aircraft seat devices, such that when a node is coupled to the master controller, the master controller recognizes the aircraft seat device coupled to the node and supplies the programs and drivers for the recognized aircraft seat device. Also, in one aspect of the invention, the node has various programs for various aircraft seat devices, such that when a node is coupled to an aircraft seat device, the node recognizes the aircraft seat device and supplies the programs and drivers for the recognized aircraft seat device. In another aspect of the invention, the master controller, a passenger control unit and/or the nodes test and/or calibrate the aircraft seat devices without external equipment.

In a further aspect of the invention, a node of an aircraft control system is provided. The node includes a memory and a microcontrol unit. The memory stores a program. The microcontrol unit retrieves the program and manipulates an aircraft seat device based on the execution of the program and upon receipt of a command to execute the program. The aircraft seat device includes an actuator and drive electronics driving the actuator and the drive electronics are proximate to the actuator. In another aspect of the invention, the microcontrol unit is further configured to independently test and calibrate the node with or without external equipment. In yet another aspect of the invention, the memory stores programs and drivers for various aircraft seat devices.

In another aspect of the invention, an aircraft seat control system is provided that includes an aircraft seat, master controller and at least one node. The aircraft seat includes at least one aircraft seat device. The node is coupled to the master controller and includes a program. The program is initiated to manipulate the at least one aircraft seat device when a command is received from the master controller.

Many of the attendant features of this invention will be more readily appreciated as the same becomes better understood by reference to the following detailed description and considered in conjunction with the accompanying drawings.

### BRIEF DESCRIPTION OF THE DRAWINGS

FIG. 1 illustrates a block diagram of one embodiment of an aircraft seat control system;

FIG. 2 illustrates a block diagram of one embodiment of a master controller;

FIG. 3 illustrates a block diagram of one embodiment of a node;

FIG. 4 illustrates a flow diagram of one embodiment of an exemplary operational process performed by a master controller;

FIG. 5 illustrates a flow diagram of one embodiment of an exemplary operational process performed by a node; and

FIG. 6 illustrates a flow diagram of one embodiment of an exemplary operational process performed by a master controller and one or more nodes.

### DETAILED DESCRIPTION OF THE INVENTION

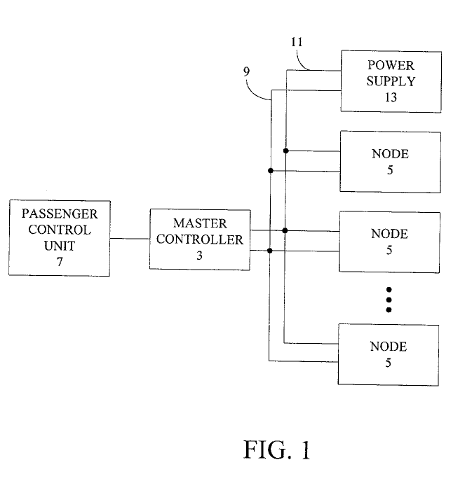

FIG. 1 illustrates a block diagram of one embodiment of an aircraft seat control system of the present invention. The system includes a master controller 3 and one or more nodes 5. The master controller is coupled to the nodes and causes one or more nodes to perform a particular action or function, such as moving an aircraft seat along an axis. The master controller, in one embodiment, transmits a program to the node. The program includes a set of instructions and/or data which enables the node to operate in a predetermined fashion. Subsequently, the master controller sends a command or message to the node to initiate the program. Therefore, the master controller issues commands to pre-program the nodes and selectively commands the nodes to execute their individual programs without further input, assistance or intervention by the master controller.

The nodes are configured to manipulate aircraft seat devices, such as seat actuators, pneumatic lumbar systems, lamp drivers, telemetry devices, sensors, solenoids, switches, power supplies and input devices. Each node is able to operate independently of each other. In one embodiment, the nodes have disparate functions and are combined based on the intended application for the system. For example, a movable aircraft seat may be configured with nodes capable of performing functions A and B, while in contrast, an aircraft seat that provides lumbar support but no movement of the aircraft seat may be configured with a node capable of performing function C. Similarly, the number of nodes depends on the functionality to be provided by the system. For instance, to provide a two-way movable seat, one node may be used, but to provide an eight-way movable seat four or more nodes may be used. As such, the number of nodes may be numerous but for readability only a few nodes are shown here.

The master controller, in one embodiment, is coupled to a passenger control unit 7. The passenger control unit or user interface receives input from a user and provides instructions and/or data to the master controller. Based on the input from the passenger control unit, the master controller causes one or more nodes to perform a particular action. In one embodiment, the master controller is removed and the passenger control unit or a switch provides direct control of or an interface to a node.

In one embodiment, an integrated in-flight entertainment controller (not shown) is provided that allows a user, e.g., a passenger or aircraft personnel, access to the aircraft seat devices. The in-flight entertainment controller assumes the functionality provided by the passenger control unit and has a compatible data interface with the master controller unit. As such, the passenger control unit is replaced by or supplemented by the in-flight entertainment controller. In one embodiment, the master controller is replaced by the in-flight entertainment controller with the entertainment controller assuming the functions of the master controller. As such, in this embodiment, the master controller is removed from the system.

The master controller is coupled to the nodes via a serial communication line 9, such as a RS485, CAN or Fieldbus serial interface. The communication bus, link, network or line allows bit-wise serial data to be transmitted between the nodes and the master controller. In one embodiment, via the communication line, the master controller and the nodes communicate to each other, e.g., transmit data, by using a common communication protocol with error checking. As such, the master controller is able to use the same or similar commands to operate different nodes that perform vastly different functions. Additionally, the common communication protocol allows the nodes and master controller to communicate with each other on a general level.

Furthermore, a typical installation, system or network can potentially contain a large number of nodes that may perform disparate functions. A systematic control language aids in managing the complexity of network transactions. Nodes that perform identical functions (e.g. actuators) utilize identical commands despite minor physical differences. Nodes that perform unique functions may have specialized commands, but will use commands common to other nodes for aspects of their function that is not unique (e.g. self test). As such, syntax and naming conventions may remain common across all network components, e.g., all the nodes.

Power is supplied to the nodes and the master controller via a power line 11 from a power supply 13. In one embodiment, the power supply is a constant DC source, e.g., a 28 volts direct current (VDC) source, which minimizes electromagnetic interference (EMI). In one embodiment, the power is supplied by one of the nodes, e.g., a power node. In another embodiment, the master or system controller provides a balance sheet style current monitoring. As such, the master controller determines the power consumption of each of the nodes and compares the total to the actual flow of current from the power supplied by the power node. Also, by recognizing fluctuations in the flow of current, the master controller detects potential faults, such as a short circuit, an inoperable node or a broken connection. In response, the master controller prevents power from being supplied to the node, shuts down the node or removes or prevents all or some of the power from flowing on the bus or network. This can be especially important when the network is constantly powered.

In one embodiment, the power is supplied by a master power supply or a seat subsystem power supply (not shown) that powers all the aircraft seat devices. Similar to adding a power node to the system, the seat subsystem power supply can also be added. In one embodiment, the power line and the serial communication line are integrated as a single line, link, bus or network connection. The network connection is a single shielded cable that includes wires for positive and negative power, positive and negative data and a safety ground. Furthermore, impedance terminators, e.g., 120 ohm terminators, are added, in some embodiments, on the network to stabilize electrical characteristics of the network. Additionally, the nodes are connected to the network using T-tap connections that provide branches in the line to allow nodes access to power and data. As such, the line is adapted to utilize standardized cables and connections and thus is simple and occupies minimal amounts of space.

In one embodiment, the network includes pass through connections. The pass through connections allow data and power to be supplied to the nodes and from the nodes without any modification or interference by any particular node. As such, with the pass through connections on the network, the nodes are coupled in a daisy chain or star configuration or a combination of both configurations. As a result, the network has shorter overall and simplified wiring harnesses, which in turn reduces cost, wire gauge and EMI emissions. In one embodiment, the wiring harness is constructed from standardized cable segments with a minimum number of routed wires.

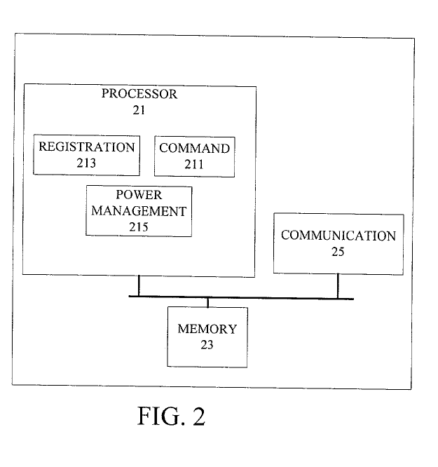

FIG. 2 illustrates a block diagram of one embodiment of a master controller. The master controller includes a processor 21 and is configured to monitor and control the nodes (FIG. 1). The master controller is also coupled to a memory 23 and a communication interface 25. In one embodiment, the master controller is a single board computer with nonvolatile program storage.

The memory 23 also stores a mathematical model of the seat kinematics which governs the seat's motion. Likewise, safety zones are defined and stored in memory. Examples of safety zones are provided in U.S. Pat. Nos. 5,651,587, 5,755,493 and 5,887,949, the disclosures of which are hereby incorporated by reference. The master controller recognizes and prevents a zone from being violated. Safety zones account for physical interference between various moving seat components and also with external objects, e.g., the floor or other seats. In one embodiment, the safety zones are defined in memory using Cartesian coordinates in a predefined mathematical model. In another embodiment, the safety zones are learned using fuzzy logic techniques. Additionally, travel limits for the nodes and system end limits are defined by a calibration process.

The memory contains data regarding the nodes which includes configuration, calibration and test information for a node. General and special software drivers is also stored in the memory to support general nodes, i.e., nodes largely provided in most aircraft seats, such as actuators, and specialized nodes, i.e., custom nodes generally application or customer specific, such as unique lighting devices. In one embodiment, a node provides data to the master controller that notifies the master controller that the node contains its own configuration, calibration and/or test information. In one embodiment, the transfer of data, e.g., a notification, to the master controller is received by the communication interface.

The communication interface couples the master controller to the serial communication line (FIG. 1) to receive and transmit information from and to the nodes. The communication interface similarly couples the master controller to the passenger control unit to receive and transmit information from and to the passenger control unit. In one embodiment, the communication interface controls the serial communication line or network. As such, a node is allowed access to the network only when the master controller gives the node permission to do so. In one example, the master controller request data from a particular node in which only that particular node is allowed access to the network to provide data to the master controller. In other words, the master controller is an active device sending requests and commands and the nodes are passive devices sending information when commanded or requested to do so by the master controller.

In one embodiment, the processor includes a command module 211. The command module is configured to query or poll each node to obtain real time information, for example, positional, speed or diagnostic information. Furthermore, the command module commands the nodes to move the seat using mathematical algorithms, models and safety zones from the memory and using the real time information from the nodes. In one embodiment, the command module interprets the real time information and transmits some or all of the information to the passenger control unit (FIG. 1). The passenger control unit, upon receipt of the information, presents the information to the user, for example, a graphical display representing the seat moving in a particular direction and speed. The command module also utilizes the information to monitor the nodes for potential errors or usage data or to log and store the information in memory.

The processor also includes a registration module 213 and a power management module 215. The registration module maintains a record of all the nodes and addresses or location of the nodes in the system. Additionally, the registration module identifies when a node is added or removed from the system. In conjunction with the command module, the registration module also recognizes and records when a node is not operational or otherwise not to be utilized. The power management module 215 manages the power supplied to the nodes by load shedding. For instance, the master controller monitors the power consumption of each node and when a predetermined limit of the total power consumption of the nodes is exceeded, the master controller reduces the speed of or turns off some or all of the nodes.

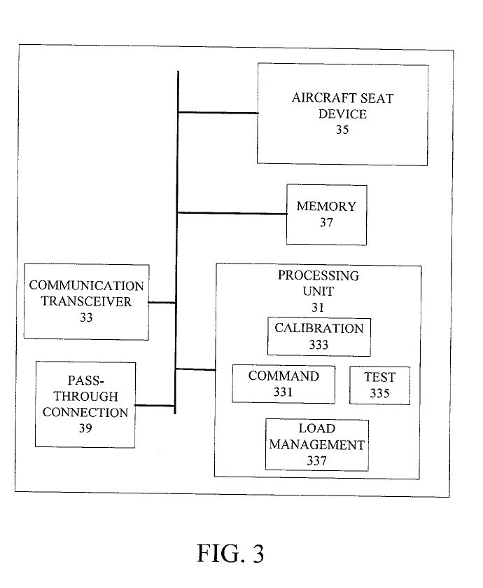

FIG. 3 illustrates a block diagram of one embodiment of a node. The node includes a microcontrol unit 31, a communication transceiver 33 and memory 37. The microcontrol unit controls one or more aircraft seat devices 35, such as a seat actuator. The microcontrol unit contains firmware with data, codes and commands to control the aircraft seat devices. In other words, the microcontrol unit formulates commands and supplies data parameters to the aircraft seat devices that causes, for example, a motor to start or move a gear which moves the aircraft seat. In one embodiment, the microcontrol unit contains a program that when executed causes an aircraft seat device to perform a particular function or functions.

The communication transceiver 33 receives information from other nodes and the master controller via the communication network. Likewise, the transceiver transmits information from the node to other nodes and the master controller. The transceiver, in one embodiment, receives information from the microcontrol unit, packages the information and sends the information to the intended recipient. In one embodiment, the transceiver is a tri-state two wire transceiver supporting (half duplex) bi-directional communication between the nodes.

In one embodiment, in sharing information between the nodes and the master controller, the nodes and master controller follow a system level network protocol. This allows a node to be added or removed from the system without performing a re-design of the system controls or software. As such, adding a more powerful actuator, pump, valve, etc., for example, in a revised application, is accomplished by disconnecting the node and replacing the node with the more powerful or improved device. Any additional programs and drivers required by the node are transferred to the node from the master controller. No re-engineering of the system controls and software is needed to integrate the new node since the node follows the system level network protocols. In one embodiment, the master controller is also removable or detachable from the system, for example, in systems requiring simple control.

The microcontrol unit also includes a command module 331. The command module interprets the commands or instructions, e.g., a program, and the associated data from the master controller or the other nodes to manipulate an aircraft seat device. In one embodiment, the command module determines and utilizes the appropriate codes, e.g., machine code, signals, e.g., providing a specific voltage or current, or data storage, e.g., writing to a particular bit in a memory element, such as a register, to manipulate an aircraft seat in accordance with the commands from the master controller. The microcontrol unit stores the programs or commands and the associated data, if any, in memory 37. In one embodiment, the microcontrol unit performs a specific action or actions as specified by the stored program.

The microcontrol unit further includes a calibration module 333 and a test module 335. The calibration module provides information to the microcontrol unit to calibrate the aircraft seat devices. For example, the calibration module defines the start and end points or additional points along an axis. In one embodiment, the passenger control unit provides or sets end points for or used by the calibration module in a production situation. For instance, the seat devices are manually operated or the passenger control unit causes the calibration module to move the aircraft seat devices in a particular direction or to a specific position. When the aircraft device reaches the specified position or is stopped by the passenger control unit via the calibration module, and, in one embodiment, upon receipt of a command from the passenger control unit, the calibration module records the position of the aircraft seat device as an end point or limit.

In another embodiment, the calibration module is self-contained and thus calibrates the nodes without needing or using external equipment. For example, the calibration module ignores any current limits and activates an aircraft seat device. The aircraft seat devices operates until a hard stop or limit, i.e., an inherent limit property of the aircraft seat device, is reached. An example of a hard stop is a point where a motor will stop turning even if the motor is commanded to turn. The calibration module records the hard stop or a location before the hard stop, e.g., a few turns before the stop, as an endpoint or limit. In one embodiment, the passenger control unit is used to further refine the limits after the calibration module performs an initial self-calibration. Therefore, the calibration module is able compensate for variations in the aircraft seat and seat devices by calibrating the aircraft seat devices with or without interaction or input from an external source.

The test module provides test sequences or commands to poll, detect or identify potential problems or errors in the microcontrol unit or in an aircraft seat device. The test module also logs or records errors and usage data in the memory 37. In one embodiment, the test module reports the errors to the master controller or another node. The test module, in one embodiment, also includes built in test equipment that provides self contained tests and diagnostic capabilities of the node and/or actuator 301. For example, the built in test equipment detects actuator failures due to over-current, overheating or excessive mechanical loads without using external equipment. The built in test equipment also collects data on the various components in the node and aircraft seat devices coupled to the node that effect the lifetime of the node, e.g., when a node may need be replaced. Thus, the built in test equipment or test and calibration module obviates the need for external test and calibration equipment.

The microcontrol unit also includes a load management module. The load management module 337 records power being consumed by the aircraft seat devices. In one embodiment, the load management module causes the microcontrol unit to power down the aircraft seat device when a predetermined condition occurs, such as when aircraft seat device is not in use or when an error is detected in the aircraft seat device. In one embodiment, the load management module self limits or budgets power consumption of the node based on a limit provided from the master controller.

The node, in one embodiment, also includes a pass through connection 39. The pass through connection provides for data and power to be supplied to the node and supplied from the node without any modification or interference by the node. As such, with a pass-through connection on each node, the nodes are coupled in a daisy chain or star configuration or a combination of both configurations.

In one embodiment, the memory 37 contains records to automatically configure the node or provides electronic data sheets. The node records the usage or utilization history of the node which, for example, assists in maintaining the node. In one embodiment, the memory is a non-volatile memory.

Various types of actuators of various sizes and configurations including, for example, brush, brushless, stepper motors, air valves and pumps, may be controlled by the nodes. However, the actuators like the nodes are generally packaged in a form that corresponds to their function, e.g., linear actuators are produced in standard stroke lengths, or are provided in a modular and standardize form. The actuators have internal drive electronics, e.g., pulse width modulation (PWM) circuitry, which being near, for example, a stepper motor minimizes EMI, as opposed to the drive electronics being placed away from the actuator, such as at the end of a cable. In one embodiment, the actuators also have internal feedback limiters that regulate the maximum amount of, for example, current, the actuator is able to utilize. The nodes are also configured to monitor and return real time or stored data on speed, direction, force, pressure, voltage, current, resistance and temperature about the actuators.

In one embodiment, a limited scope system or environment is defined. For example, an aircraft seat having only two actuators without any complex control definitions, such as safety zones, is defined in which a single node or a couple of nodes are utilized without assistance of a master controller. In this case, the nodes operate in a stand-alone mode and execute programs directed to the functions provided by the actuators. In another example of a limited scope system, a node is provided for moving privacy screens or access doors. The nodes may receive input from, for example, a switch and does not require communication with the other nodes or a master controller.

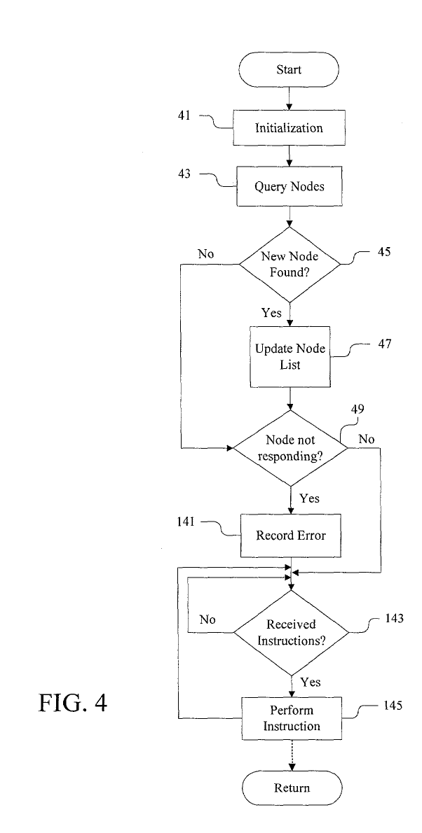

FIG. 4 illustrates a flow diagram of one embodiment of an exemplary operational process performed by a master controller. In block 41, the process initializes the master controller's components, such as zeroing registers or memory locations, and sending commands to the nodes to similarly perform initialization procedures. The process polls or sends status commands to the nodes to identify the current operational status of each of the nodes in block 43. If the process determines that a new node is found, i.e., a node has been added or removed from the system, in block 45, the process updates a node list in block 47. Otherwise, the process continues to block 49.

In block 49, if the process determines that a node is not operating properly, the process records the status and removes the node from the node list or otherwise indicates the status of the node on the node list in block 141. In one embodiment, the determination of the node operating properly is based on data provided by the node compared to a predetermined standard or based on a message sent by the node. If the process determines that all the nodes are operating properly, the process continues to block 143 in which the process provides information, such as programs or drivers, required or requested by the nodes. The process waits in block 143 until an instruction from an external source, e.g., a passenger control unit, is received. If an instruction is received, the process in block 145 interprets the instructions and causes the nodes to manipulate an aircraft seat device or devices. In one embodiment, the process in block 145 also provides information, such as data or programs required by the node to carry out the instruction. The process returns when the master controller is provided a shutdown or reset instruction or power is externally removed. Otherwise, the process continues to wait for additional instructions in block 143.

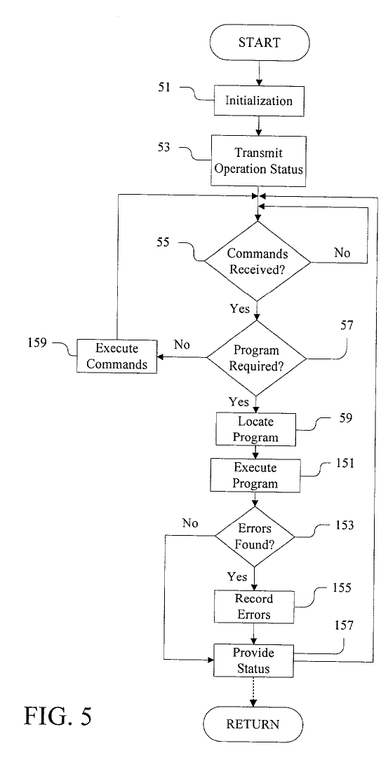

FIG. 5 illustrates a flow diagram of one embodiment of an exemplary operational process performed by a node. In block 51, the process initializes the node and performs a self calibration of an aircraft seat device. The process sends status information to an external source, for example, the master controller, to identify that the node is operational and ready to receive commands in block 53. In block 55, the process awaits commands from an external source, for example, the master controller. If the process receives a command, the process determines if a program or other similar type of data is required to perform the command in block 57.

If the process determines in block 57, that a program is not required, the process executes the command and manipulates the aircraft seat device accordingly in block 159 and continues to block 55. If the process determines that a program is required, the process in block 59 locates the program. In one embodiment, the process retrieves the program from memory. In another embodiment, the process sends a request to an external source to obtain the program. Once the program is located, the process executes the program in block 151. In block 153, the process determines if any errors occur due to the execution of the program. If errors have occurred, the process records the error in block 155 and provides status information to the external source in block 157. The process repeats continuing to block 55 to await further commands from the external source. The process returns when the node is provided a shutdown or reset instruction or power is externally removed.

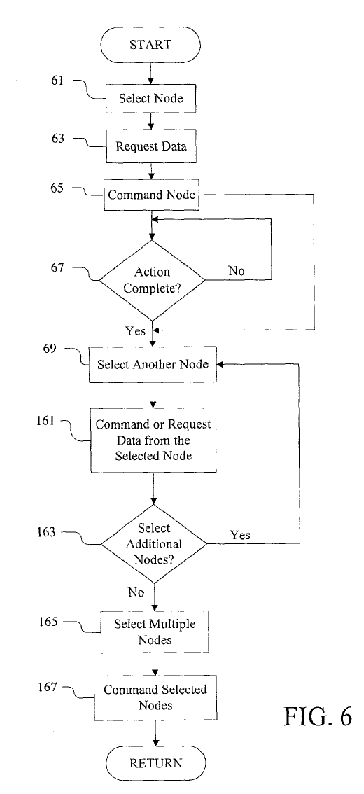

FIG. 6 illustrates a flow diagram exemplifying one embodiment of a master controller and nodes operating together to manipulate an aircraft seat. In block 61, the process selects a node. For instance, the master controller transmits, for example, the command “address(5)”, to select a node having the unique address of five. The node responds by sending an acknowledgement response or signal. The commands and their structure described here and below are provided as examples. In block 63, the process requests data or information from the selected node. For example, the master controller sends a position request in which the node provides the current position of an actuator, e.g., 0595.

The process, in block 65, based on the information provided by the node, commands the node. For instance, the master controller sets and provides a temporary travel limit to the node. An example set command, such as “tempmaxlim 0700”, provided by the master controller, commands the node to set a temporary limit at 700 for the actuator. The node acknowledges receipt of the set command. The master controller then sends a move command to cause the node to move an actuator. A “move +015!!” command, for example, is sent from the master controller to the selected node to cause the node to move an actuator for “015” ticks per second in a “+” positive direction.

In block 67, the process waits until the action taken by the node is complete. In one instance, the selected node sends a completion message to the master controller to notify the master controller that the action, e.g., the moving of the actuator to the limit of 700 for 15 ticks per second in a positive direction, has been performed. In one embodiment, the move command includes an identifier, such as the “!!” in the example command, indicating that the master controller will await a response from the node, e.g., a completion message. Additionally, in one embodiment, the master controller acknowledges receipt of the completion message. In one embodiment, the node acknowledges receipt of all messages sent from the master controller and directed to the node.

Once the process determines that the action taken by the node is complete, the process continues to block 69. In one embodiment, the process does not wait until the action taken by the node is complete. Thus, the process skips block 67 and continues to block 69. By not waiting for a node to complete a commanded operation, multiple nodes are able to operate independently and simultaneously to perform separate and different functions, such as moving a seat forward and turning on a light, or work together to perform a particular function, such as engaging two pneumatic motors to inflate two separate bladders for a common lumbar support.

In block 69, the process selects another node and, in block 161, requests information from the selected node or commands the selected node. For example, the master controller selects another node having address two by transmitting the command “address(2)” and instructs the node to move at 20 ticks per second in a positive direction by sending the command “move +20!”. The node acknowledges receipt of the selection and the instruction and thereby causes an actuator to move at 20 ticks per second in a positive direction.

In block 163, the process determines if additional nodes are to be selected and controlled, for example, to perform a common operation. If the process determines that additional nodes are needed, the process repeats continuing back to block 69. For instance, the master controller subsequently addresses node four and commands the node to move in a negative direction at 15 ticks per second. Node four, similar to node two, acknowledges receipt of the selection of the node and the move command and causes an actuator to move at 15 ticks per second in a negative direction. The master controller, to monitor the common operation, also selects the nodes and requests information from the nodes. For example, the master controller selects node 2 and requests positional and speed information from the node. In one embodiment, the node reports a specific position or a zero speed, e.g., signaling that the motor has stopped. The master controller is thereby implicitly informed that the action commanded by the master controller or the common operation has been completed.

Additionally, the process can command the nodes to perform various other operations beyond moving an aircraft seat or device. For instance, in one embodiment, the master controller sends a built-in test command to a selected node and thereby causes a node to perform predefined tests. The master controller subsequently requests the error information or test results from the selected node.

If the process determines that additional nodes are not needed, the process continues to block 165 selects all or a set of nodes by the master controller addressing node 0, e.g., sending an “address (0)” command. The process in block 167 sends a command to all the selected nodes and the process returns. For example, the master controller sends a stop command to cause all the nodes selected to stop.

In another embodiment, the process, in block 161, instead of commanding or requesting data from a node, programs the selected node. For example, the master controller sends a program command to cause the node to move an actuator. A “move +020.” command, for example, is sent from the master controller to the selected node to cause the node to move an actuator for “020” ticks per second in a “+” positive direction when a start command is received. In one embodiment, the program command includes an identifier, such as the “.” in the example command, indicating that the node will await a command from the master controller, e.g., a start command, before performing the program. In one embodiment, the process continues to select additional nodes and program the selected node repeating blocks 163, 69 and 161. In block 165, the process selects the program nodes, e.g., the master controller sending an “address (0)” command and in block 167, and commands the nodes to execute their programs. For example, the master controller sends or broadcasts a start command to the selected nodes to perform their pre-programmed instructions.

Although the processes above describe actions being taken in a particular order, the actions could be performed in many different orders and combinations based on the intended functionality or application of the system. Additionally, the nodes may be commanded to perform additional and alternative actions then those described above.

In one embodiment, the process and modules are implemented in software, hardware or both. Those of skill in the art will recognize how to transform the process and modules into circuit elements either manually or using an HDL such as VHDL or Verilog. Likewise, the processes, modules and other functions of the master controller and the nodes can be transformed into programs in the C or C++ programming language or scripts, such as in the PERL programming language. C and C++ compilers, PERL interpreters and the C, C++ and PERL programming languages, and the uses thereof, are well known and often used by software developers. Furthermore, even though the modules in the nodes and master controller are described as separate items, all the modules could be combined as a single program or hardwired in the respective master controller and nodes, separately or as one.

Accordingly, the present invention provides methods and systems that provide a distributed control of devices for manipulating aircraft seats. Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive. The scope of the invention to be determined by the appended claims, their equivalents and claims supported by the specification rather than the foregoing description.

What is claimed is:

1. An aircraft seat control system comprising:
master controller; and
at least one node coupled to the master controller, the at least one node including a program;
wherein the program is initiated to manipulate an aircraft seat device when a command is received from the master controller.

2. The system of claim 1 wherein the master controller provides the program to the at least one node.

3. The system of claim 1 wherein the master controller detects when a node is removed from the system.

4. The system of claim 1 wherein the master controller detects when a node is added to the system.

5. The system of claim 1 wherein the master controller is an in-flight entertainment unit.

6. The system of claim 1 wherein the master controller manages power consumed by the at least one node.

7. The system of claim 6 wherein the master controller records the power consumed and disables the at least one node when a specific power threshold is exceeded.

8. The system of claim 6 wherein the master controller records the power consumed and commands the at least one node to reduce speed of an actuator when a specific power threshold is exceeded.

9. The system of claim 6 wherein the master controller records the power consumed and commands the at least one node to reduce power consumption when a specific power threshold is exceeded.

10. The system of claim 1 wherein the master controller periodically tests the at least one node.

11. The system of claim 10 wherein the master controller records errors and test data reported by the at least one node.

12. The system of claim 1 wherein the at least one node performs predetermined tests without external equipment and transmits test results to the master controller.

13. The system of claim 1 wherein the at least one node performs predetermined tests and transmits test results to the master controller.

14. The system of claim 12 wherein the master controller executes a predetermined function when the test results indicate an occurrence of an error.

15. The system of claim 1 wherein the master controller controls the at least one node to manipulate the aircraft seat devices within predetermined safety zones.

16. The system of claim 15 wherein the safety zones are determined by using a mathematical algorithm and based on positional information.

17. The system of claim 15 wherein the safety zones are determined by using fuzzy logic and based on positional information.

18. The system of claim 15 wherein the master controller commands at least one node based on data from the at least one node.

19. The system of claim 1 further comprising a node acting as a power supply.

20. The system of claim 1 further comprising a master power supply supplying power to the at least one node, the master controller and other in-seat devices.

21. The system of claim 1 further comprising a node that is added based on a revised application.

22. The system of claim 1 wherein the master controller comprises various programs for various aircraft seat devices, such that when a node is coupled to the master controller, the master controller recognizes an aircraft seat device coupled to the node.

23. The system of claim 22 wherein the master controller supplies programs and drivers for the recognized aircraft seat device.

24. The system of claim 1 wherein the at least one node comprises various drivers for various aircraft seat devices.

25. The system of claim 24 wherein the at least one node supplies drivers for an aircraft seat device, when a node is coupled to the master controller.

26. The system of claim 25 wherein the at least one node is configured to self calibrate the aircraft seat device without external equipment.

27. The system of claim 25 wherein the at least one node is configured to determine limits of the aircraft seat device by independently manipulating the aircraft seat device.

28. The system of claim 25 wherein the at least one node is configured to self calibrate the aircraft seat device.

29. The system of claim 25 wherein the master controller is configured to calibrate the aircraft seat device.

30. The system of claim 24 further comprising a passenger control unit that facilitates calibration of the aircraft seat device.

31. The system of claim 1 wherein the at least one node operates independently from the master controller.

32. The system of claim 1 further comprising a user interface and wherein the master controller transmits commands to the at least one node based on input from the user interface.

33. The system of claim 32 wherein the master controller executes a program based on input from the user interface.

34. The system of claim 32 wherein the user interface is a passenger control unit.

35. The system of claim 32 wherein the user interface is an in-flight entertainment unit.

36. The system of claim 1 wherein the master controller commands a node based on data from the at least one node.

37. The system of claim 1 wherein the master controller and the at least one node is coupled to each other via serial communication network.

38. The system of claim 37 wherein the communication network comprises a t-tap connection.

39. The system of claim 37 wherein the communication network comprises pass through connections.

40. The system of claim 37 wherein the master controller and the node communicate using a common communication protocol.

41. The system of claim 37 wherein the master controller controls the communication network.

42. A node of an aircraft seat control system, the node comprising:
a memory storing a program;
a microcontrol unit configured to retrieve the program and manipulate an aircraft seat device based on the execution of the program and upon receipt of a command to execute the program.

43. The node of claim 42 wherein the aircraft seat device comprises an actuator and drive electronics driving the actuator, the drive electronics being proximate to the actuator.

44. The node of claim 42 wherein the microcontrol unit is further configured to independently test the node.

45. The node of claim 42 wherein the microcontrol unit is further configured to self test the node without using external equipment.

46. The node of claim 42 wherein the microcontrol unit is further configured to independently calibrate the node.

47. The node of claim 42 wherein the microcontrol unit is further configured to self calibrate the node without using external equipment.

48. The node of claim 42 wherein the memory stores programs and drivers for various aircraft seat devices.

49. An aircraft seat control system comprising:
aircraft seat having at least one aircraft seat device;
master controller; and
at least one node coupled to the master controller, the at least one node including a program;
wherein the program is initiated to manipulate the at least one aircraft seat device when a command is received from the master controller.
